(19) United States
(12) Patent Application Publication
(10) Pub. No.: US 2018/0157367 A1
(43) Pub. Date: Jun. 7, 2018

(54) ANALOG SELF CAPACITANCE SENSING FRONT END UTILIZING CURRENT CONVEYORS

(71) Applicant: STMicroelectronics Asia Pacific Pte Ltd, Singapore (SG)

(72) Inventor: Leonard Liviu Dinu, Singapore (SG)

(73) Assignee: STMicroelectronics Asia Pacific Pte Ltd, Singapore (SG)

(21) Appl. No.: 15/368,203

(22) Filed: Dec. 2, 2016

(51) Int. Cl. G06F 3/041; G06F 3/044

(52) U.S. Cl. CPC G06F 3/0416; G06F 3/044

(57) ABSTRACT

A touch screen controller includes a current conveyor having first and second inputs and first and second outputs, the first input being coupled to a self capacitance sense line. A driver is coupled to the second input and periodically drives the second input between high and low voltages. The current conveyor forces its first input to a same voltage as its second input, and replicates a current flowing into its first input at its first and second outputs, such that when the driver drives the second input to the high voltage, a first current flows from the first input into the self capacitance sense line, and when the driver drives the second input to the low voltage, a second current flows from the self capacitance sense line into the first input, and the current conveyor replicates the second current to its first and second outputs.

### FIELD OF THE INVENTION

This invention relates to self capacitance sensing and, more particularly, to an analog front end that uses current conveyors to enable high frequency self capacitance sensing.

### BACKGROUND

A touch screen is a device that can detect an object in contact with or in proximity to a display area. The display area can be covered with a touch-sensitive matrix that can detect a user's touch by way of a finger or stylus, for example. Touch screens are used in various applications such as smartphones, tablets, smartwatches, wearables, and other mobile devices. A touch screen may enable various types of user input, such as touch selection of items on the screen or alphanumeric input via a displayed virtual keypad. Touch screens can measure various parameters of the user's touch, such as the location, duration, etc.

One type of touch screen is a capacitive touch screen. A capacitive touch screen may include a matrix of conductive lines and conductive columns overlaid on the display area. The conductive lines and the conductive columns do not contact each other. The capacitive touch screen may be used for self capacitance sensing.

In self capacitance sensing, the capacitance between a conductive element of the capacitive touch matrix and a reference voltage, such as ground, is sensed. A change in the sensed capacitance may indicate that an object, such as a finger, is touching the screen or is in proximity to the screen near the conductive element being sensed. The scanning of the capacitive touch matrix involves alternate sensing of the conductive lines and the conductive columns.

Existing analog self capacitance sensing front ends are limited to low frequency applications where the self capacitance of the lines and columns of the matrix is high. This limitation to low frequency applications in turn limits external noise rejection, as the noise harmonics may have a higher power at lower frequencies. Moreover, during a given scan duration, low frequency scanning results in fewer samples, which is not advantageous for averaging out intrinsic noise in the touch screen device.

Therefore, further development in the area of analog front ends for self capacitance sensing is needed.

### SUMMARY

This summary is provided to introduce a selection of concepts that are further described below in the detailed description. This summary is not intended to identify key or essential features of the claimed subject.

Disclosed herein is a touch screen controller (TSC). The TSC includes a plurality of current conveyors, with each current conveyor having first and second inputs and first and second outputs. The first input of each current conveyor is coupled to a different one of a plurality of self capacitances from a plurality of sense lines. A driver is coupled to the second input of each current conveyor. The driver is configured to periodically drive the second input of each current conveyor between a first voltage and a second voltage less than the first voltage. Each of the plurality of current conveyors is configured to force its first input to a same voltage as its second input, and to replicate a current flowing into its first input at its first and second outputs, such that: when the driver drives the second input of each current conveyor to the first voltage, a different first current flows from the first input of each current conveyor into its associated self capacitance, charging the self capacitance by a known amount, and when the driver drives the second input of each current conveyor to the second voltage, a different second current flows from each self capacitance to the first input of its associated current conveyor, and that second current flows from the first and second outputs of that current conveyor as a sense current for the sense line associated with that current conveyor.

Also disclosed herein is a touch screen controller including a first current conveyor having first and second inputs and first and second outputs, the first input of the first current conveyor being coupled to a first self capacitance sense line. A second current conveyor has first and second inputs and first and second outputs, the first input of the second current conveyor being coupled to a second self capacitance sense line. A driver is coupled to the second input of the first current conveyor and the second input of the second current conveyor, with the driver is configured to periodically drive the second inputs of the first and second current conveyors between high and low voltages. The first current conveyor is configured to force its first input to a same voltage as its second input, and to replicate a current flowing into its first input at its first and second outputs, such that: when the driver drives the second input of the first current conveyor to the high voltage, a first current flows from the first input of the first current conveyor into the first self capacitance sense line; and when the driver drives the second input of the first current conveyor to the low voltage, a second current flows from the first self capacitance sense line into the first input of the first current conveyor, and the first current conveyor replicates the second current to its first and second outputs as a sense current for a sense line associated with the first self capacitance sense line. The second current conveyor is configured to force its first input to a same voltage as its second input, and to replicate a current flowing into its first input at its first and second outputs, such that: when the driver drives the second input of the second current conveyor to the high voltage, a first current flows from the first input of the second current conveyor into the first self capacitance sense line; and when the driver drives the second input of the second current conveyor to the low voltage, a second current flows from the first self capacitance sense line into the first input of the second current conveyor, and the second current conveyor replicates the second current to its first and second outputs as a sense current for a sense line associated with the second self capacitance sense line.

Further disclosed herein is an electronic device having a plurality of current conveyors, each current conveyor having first and second inputs and first and second outputs. The first input of each current conveyor is couplable to a different one of a plurality of self capacitances from a plurality of sense lines. A driver is coupled to the second input of each current conveyor, wherein the driver is configured to periodically drive the second input of each current conveyor between a first voltage and a second voltage less than the first voltage. The electronic device also includes a plurality of current to voltage converters, each current to voltage converter having first and second inputs coupled to the first or second outputs of different current conveyors of the plurality of current conveyors, and outputting a sense voltage.

Also disclosed herein is an electronic device with a first current conveyor having first and second inputs and first and second outputs, the first input of the first current conveyor being coupled to a first self capacitance. A second current conveyor has first and second inputs and first and second outputs, the first input of the second current conveyor being coupled to a second self capacitance. A driver is coupled to the second input of the first current conveyor and the second input of the second current conveyor, with the driver being configured to periodically drive the second inputs of the first and second current conveyors between high and low voltages. A first current to voltage converter has a first input coupled to the second output of the first current conveyor, a second input coupled to the first output of the second current conveyor, and is configured to output a first sense voltage. A second current to voltage converter has a first input coupled to the second output of the second current conveyor, a second input to be coupled to an additional current conveyor, and is configured to output a second sense voltage.

Another aspect is directed to a touch screen controller including a current conveyor having first and second inputs and first and second outputs, the first input of the current conveyor being coupled to a self capacitance sense line. The touch screen controller also includes a driver coupled to the second input of the current conveyor, with the driver being configured to periodically drive the second input of the current conveyor between high and low voltages. The current conveyor is configured to force its first input to a same voltage as its second input, and to replicate a current flowing into its first input at its first and second outputs, such that: when the driver drives the second input of the current conveyor to the high voltage, a first current flows from the first input of the current conveyor into the self capacitance sense line; and when the driver drives the second input of the current conveyor to the low voltage, a second current flows from the self capacitance sense line into the first input of the current conveyor, and the current conveyor replicates the second current to its first and second outputs as a sense current for the self capacitance sense line.

Also disclosed is a touch screen controller including a first current conveyor configured to charge a first self capacitance line, discharge the first self capacitance line, sense a first current resulting from discharge of the first self capacitance line, and replicate the sensed first current to first and second outputs as a first sense current for the first self capacitance line. A second current conveyor is configured to charge a second self capacitance line, discharge the second self capacitance line, sense a second current resulting from discharge of the second self capacitance line, and replicate the sensed second current to first and second outputs as a second sense current for the second self capacitance line. A differential integrator is coupled to receive the first and second sense currents and to generate a sense voltage as a function of a difference between the first and second sense currents.

### BRIEF DESCRIPTION OF THE DRAWINGS

FIG. 1 is a schematic representation of a capacitive touch matrix;

FIG. 2 is a schematic diagram of a touch screen system;

FIG. 3 is a schematic diagram of a touch screen controller for use with the touch screen system of FIG. 2.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout.

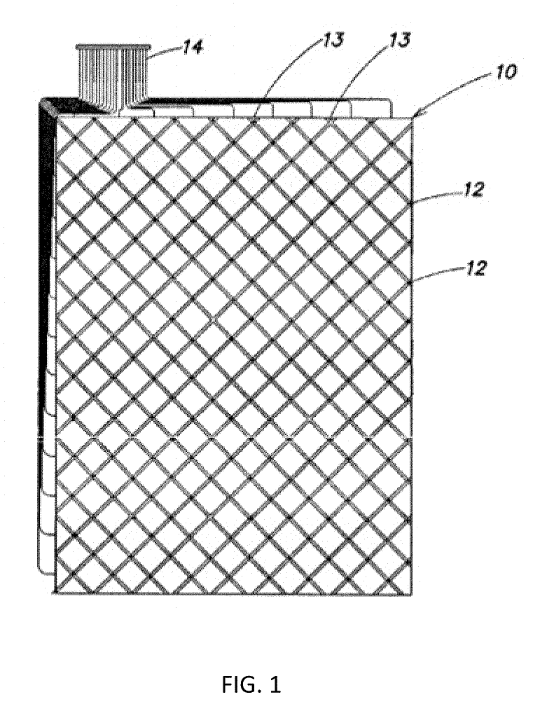

FIG. 1 shows an example of a touch screen having conductive lines 12 and conductive columns 13 of a capacitive touch matrix 10, arranged in a diamond pattern. The capacitive touch matrix 10 may be transparent to allow light from an underlying display unit to pass through the capacitive touch matrix 10 for viewing by a user. A plurality of conductors 14 may be provided for making contact to conductive lines 12 and conductive columns 13. Conductive lines 12 and conductive columns 13 may cover substantially the entire face of the touch screen, enabling touch and proximity detection at substantially any location on the touch screen.

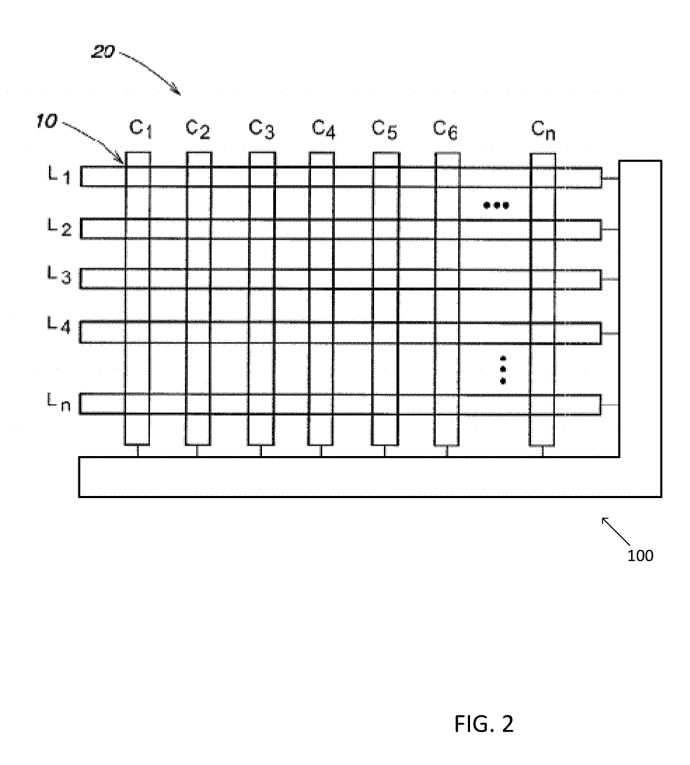

FIG. 2 is a block diagram of a touch screen system 20 that includes the capacitive touch matrix 10 and an associated analog front end 100. As discussed above, the capacitive touch matrix 10 may have a diamond pattern, which is not shown in FIG. 2 for clarity. In self capacitance sensing, a forcing signal is applied to the column conductors C1-Cn, and the capacitance to ground is sensed on the same column conductors C1-Cn. Then, a forcing signal is applied to the line conductors L1-Ln, and the capacitance to ground is sensed on the same line conductors. The combined information from column self sensing and line self sensing indicates the location of a touch on the capacitive touch matrix. The sequence of sensing on column conductors and sensing on line conductors is repeated. This operation is performed by the analog front end 100.

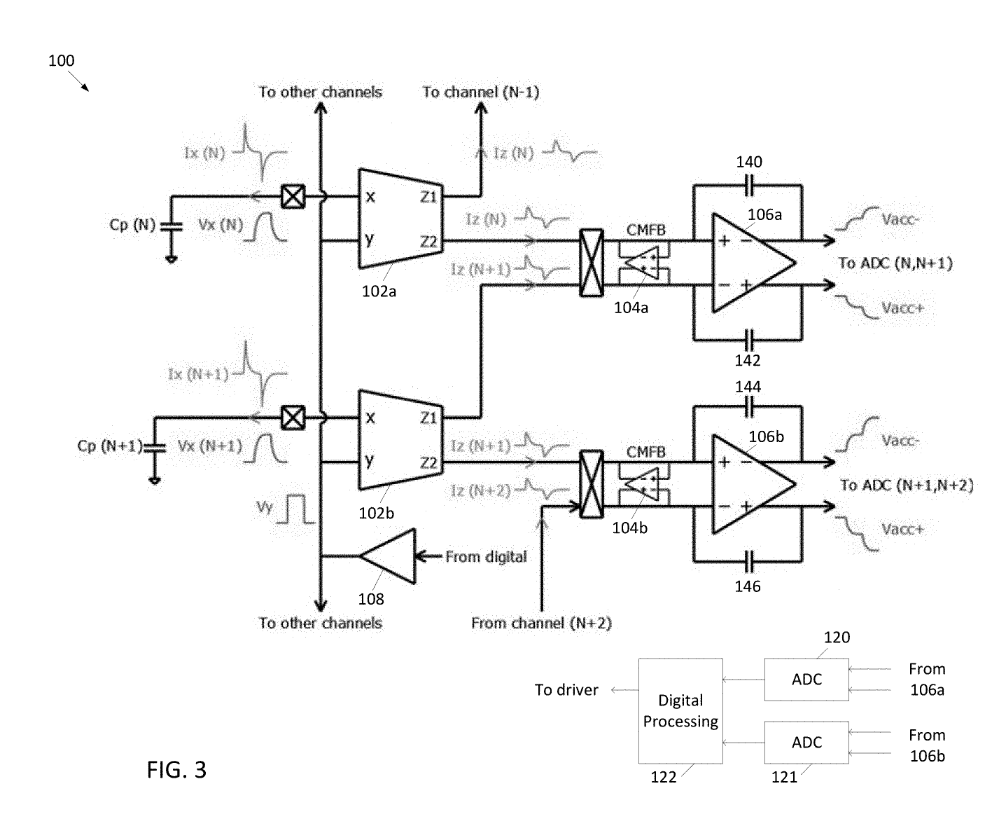

An analog front end 100 for self capacitance sensing is now described with additional reference to FIG. 3. The analog front end 100 may be incorporated within a touch screen controller. Self capacitances Cp(N) and Cp(N+1) are shown, representing the self capacitances of a row or column.

The first self capacitance Cp(N) is coupled to the “x” input of current conveyor 102a, and the second self capacitance Cp(N+1) is coupled to the “x” input of current conveyor 102b. A driver 108 serves to drive the “y” inputs of current conveyors 102a and 102b, as will be explained below.

Current conveyor 102a has a first output Z1 that is for use in circuitry associated with a N−1′th channel of the analog front end, and a second output Z2 that is coupled to the non-inverting input of differential amplifier 106a. Current conveyor 102b has a first output Z1 that is coupled to the inverting input of differential amplifier 106a, and a second output Z2 that is coupled to the non-inverting input of differential amplifier 106b.

First integration capacitor 140 is coupled between the non-inverting input and inverting output of differential amplifier 106a, and second integration capacitor 142 is coupled between the inverting input and non-inverting output of differential amplifier 106a. Similarly, third integration capacitor 144 is coupled between the non-inverting input and inverting output of differential amplifier 106b, and fourth integration capacitor 146 is coupled between the inverting input and non-inverting output of differential amplifier 106b. The capacitors 140, 142, 144, 146 have the same values in some applications.

Amplifier 104a forms a common mode feedback circuit and has its non-inverting input and its inverting output coupled to the non-inverting input of amplifier 106a, and has its inverting input and its non-inverting output coupled to the inverting input of amplifier 106a. Amplifier 104b also forms a common mode feedback circuit and has its non-inverting input and its inverting output coupled to the non-inverting input of amplifier 106b, and has its inverting input and its non-inverting output coupled to the inverting input of amplifier 106b.

The outputs of amplifier 106a are coupled to provide output to analog to digital converter (ADC) 120. The outputs of amplifier 106b are coupled to provide output to ADC 121. ADCs 120 and 121 are coupled to provide output to digital processing block 122, which provides a control signal to driver 108.

The current conveyors 102a, 102b function as current conveyors as known to those of skill in the art. Details on the internal structure and the operation of current conveyors may be found in The Current Conveyor—A New Circuit Building Block, by Sedra and Smith, Proceedings of the IEEE, August 1968, pages 1368-1369, the contents of which are hereby incorporated by reference in their entirety for all purposes. It is to be understood that the current conveyors 102a, 102b function as the current conveyors described in this incorporated reference, but with current mirroring circuitry on the output such that each current conveyor 102a, 102b has two outputs Z1, Z2 that provide substantially similar or substantially identical outputs.

Generally speaking, current conveyors function as follows. The voltage at the “x” input follows the input at the “y” input, such that a voltage applied to the “y” input is forced at the “x” input; and a current flowing into the “x” input is cloned, potentially in high impedance form, to the “Z1” and “Z2” outputs.

With that understanding, operation of the analog front end 100 is now described. The driver 108 drives the “y” inputs of the current conveyors 102a, 102b between high and low voltages with a periodic signal, shown in FIG. 3 as the signal Vy. When the “y” inputs of the current conveyors 102a, 102b are driven high, due to the self capacitances Cp(N) and Cp(N+1) being coupled between the “x” inputs of the current conveyors 102a, 102b and a reference voltage (that is less than the high voltage from the driver 108), the “x” inputs of the current conveyors 102a, 102b are driven high as well, resulting in current flowing from the “x” inputs into the self capacitances Cp(N) and Cp(N+1) and charging the self capacitances by a further known amount.

When the “y” inputs of the current conveyors 102a, 102b are driven low, due to the self capacitances Cp(N) and Cp(N+1) being coupled between the “x” inputs of the current conveyors 102a, 102b and a reference voltage (that is greater than the low voltage from the driver 108), current flows from the self capacitances Cp(N) and Cp(N+1) into the “x” inputs. These currents are labeled as Ix(N) and Ix(N+1) in FIG. 3, and their values are a function of the charge on Cp(N) and Cp(N+1) due to the “x” inputs being forced to the low voltage by the current conveyors 102a, 102b. Since the self capacitances Cp(N) and Cp(N+1) have different values, the currents flowing therefrom and into the “x” inputs are different.

The current conveyors 102a, 102b function to replicate the currents flowing into the “x” inputs onto their Z1 and Z2 outputs as Iz(N) for current conveyor 102a and Iz(N+1) for current conveyor 102b. Thus, currents Iz(N) and Iz(N+1) are sense currents having values which are a function of the self capacitances Cp(N) and Cp(N+1), which themselves represent touch data.

The amplifiers 104a, 104b serve to reject the common mode currents from the inputs of the differential amplifiers 106a, 106b. Differential amplifiers 106a, 106b are fully differential, having differential inputs and differential outputs, and are arranged as differential integrators. Thus, the differential amplifiers 106a, 106b function to convert to voltages and amplify the difference between the currents received at their inputs, producing differential sense voltages representing touch data at their outputs. These differential sense voltages are converted to the digital domain by analog to digital converters 120 and 121, and may then be further processed by digital processing block 122. The digital processing block 122 also happens to function to control the driver.

As will be shown mathematically, the output of the differential amplifiers 106a, 106b is independent of transients, and is dependent on the difference between the values of the self capacitances.

Mathematically represented, channels (N) and (N+1):

$${V}_{acc} ( N , N + 1 ) = {V}_{acc +} - {V}_{acc -} = \frac{2 \cdot {\int }_{0}^{T} [ {I}_{Z} ( N + 1 ) - {I}_{Z} ( N ) ] \cdot dt}{{C}_{int}}$$

where T is the time taken for 1 sample, and V_{acc+} and V_{acc-} are the differential outputs of the differential amplifiers 106a, 106b.

The relation of the currents Ix(N) and Ix(N+1) into the “x” inputs of the current conveyors 102a, 102b to Cp(N) and Cp(N+1) is:

∫₀^{T}[I_{X}(N+1)−I_{X}(N)]·dt=[Cₚ(N+1)−Cₚ(N)]·(V_{high}−V_{low})

Therefore:

$${V}_{acc} ( N , N + 1 ) = \frac{2 * ( {V}_{high} - {V}_{low} )}{m * {C}_{int}} = [ {C}_{p} ( N + 1 ) - {C}_{P} ( N ) ]$$

Thus, the output of the differential amplifiers 106a, 106b, as stated, is independent of the transients.

It should be understood that the analog front end 100 may contain any number of current conveyors to service any number of self capacitances. Where the Z1 output of current conveyor 102a states “to channel (N−1)”, it is meant that that Z1 output will be coupled to the inverting input of the differential amplifier for channel (N−1). Similarly, where inverting input of differential amplifier 106b received input “from channel (N+2)”, it is meant that it is receiving the Z1 input from the current conveyor of channel (N+2). Thus, the analog front end 100 may service any number of columns C1-Cn and lines L1-Ln.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

1. A touch screen controller, comprising:
a plurality of current conveyors, each current conveyor having first and second inputs and first and second outputs;
wherein the first input of each current conveyor is coupled to a different one of a plurality of self capacitances from a plurality of sense lines;
a driver coupled to the second input of each current conveyor, wherein the driver is configured to periodically drive the second input of each current conveyor between a first voltage and a second voltage less than the first voltage;
wherein each of the plurality of current conveyors is configured to force its first input to a same voltage as its second input, and to replicate a current flowing into its first input at its first and second outputs, such that:
when the driver drives the second input of each current conveyor to the first voltage, a different first current flows from the first input of each current conveyor into its associated self capacitance, charging the self capacitance by a known amount;
when the driver drives the second input of each current conveyor to the second voltage, a different second current flows from each self capacitance to the first input of its associated current conveyor, and that second current flows from the first and second outputs of that current conveyor as a sense current for the sense line associated with that current conveyor.

2. The touch screen controller of claim 1, further comprising:
a plurality of current to voltage converters, each current to voltage converter having first and second inputs coupled to the first or second outputs of different current conveyors of the plurality of current conveyors, and outputting a sense voltage.

3. The touch screen controller of claim 2, wherein the plurality of current to voltage converters are differential integrators, having differential inputs and differential outputs; and wherein the sense voltage is output as a pair of differential sense voltages.

4. The touch screen controller of claim 2, further comprising an analog to digital converter coupled to the output of each of the plurality of current to voltage converters and configured to generate a digital sense voltage from the sense voltage.

5. The touch screen controller of claim 2, further comprising a plurality of amplifiers, each amplifier associated with one of the plurality of current to voltage converters and configured to reject a common mode current present at inputs of its associated current to voltage converter.

6. A touch screen controller, comprising:
a first current conveyor having first and second inputs and first and second outputs, the first input of the first current conveyor being coupled to a first self capacitance sense line;
a second current conveyor having first and second inputs and first and second outputs, the first input of the second current conveyor being coupled to a second self capacitance sense line;
a driver coupled to the second input of the first current conveyor and the second input of the second current conveyor, wherein the driver is configured to periodically drive the second inputs of the first and second current conveyors between high and low voltages;
wherein the first current conveyor is configured to force its first input to a same voltage as its second input, and to replicate a current flowing into its first input at its first and second outputs, such that:
when the driver drives the second input of the first current conveyor to the high voltage, a first current flows from the first input of the first current conveyor into the first self capacitance sense line;
when the driver drives the second input of the first current conveyor to the low voltage, a second current flows from the first self capacitance sense line into the first input of the first current conveyor, and the first current conveyor replicates the second current to its first and second outputs as a sense current for a sense line associated with the first self capacitance sense line;
wherein the second current conveyor is configured to force its first input to a same voltage as its second input, and to replicate a current flowing into its first input at its first and second outputs, such that:
when the driver drives the second input of the second current conveyor to the high voltage, a first current flows from the first input of the second current conveyor into the first self capacitance sense line;
when the driver drives the second input of the second current conveyor to the low voltage, a second current flows from the first self capacitance sense line into the first input of the second current conveyor, and the second current conveyor replicates the second current to its first and second outputs as a sense current for a sense line associated with the second self capacitance sense line.

7. The touch screen controller of claim 6, further comprising:
a first current to voltage converter having a first input receiving the sense current from the second output of the first current conveyor, a second input receiving the sense current from the first output of the second current conveyor, and configured to output a first sense voltage; and
a second current to voltage converter having a first input receiving the sense current from the second output of the second current conveyor, a second input receiving a sense current from an additional current conveyor, and configured to output a second sense voltage.

8. The touch screen controller of claim 7, wherein the first and second current to voltage converters are differential integrators, each having differential inputs and differential outputs; and wherein the first sense voltage is output as a pair of first differential sense voltages and the second sense voltage is output as a pair of second differential sense voltages.

9. The touch screen controller of claim 7, further comprising an analog to digital converter coupled to the output of the first and second current to voltage converters and configured to generate first and second digital sense voltages from the first and second sense voltages.

10. The touch screen controller of claim 7, further comprising a first common mode rejection circuit coupled to the first and second inputs of the first current to voltage converter, and a second common mode rejection circuit coupled to the first and second inputs of the second current to voltage converter.

11. An electronic device, comprising:
a plurality of current conveyors, each current conveyor having first and second inputs and first and second outputs;
wherein the first input of each current conveyor is couplable to a different one of a plurality of self capacitances from a plurality of sense lines;
a driver coupled to the second input of each current conveyor, wherein the driver is configured to periodically drive the second input of each current conveyor between a first voltage and a second voltage less than the first voltage; and
a plurality of current to voltage converters, each current to voltage converter having first and second inputs coupled to the first or second outputs of different current conveyors of the plurality of current conveyors, and outputting a sense voltage.

12. The electronic device of claim 11, wherein the plurality of current to voltage converters are differential integrators, having differential inputs and differential outputs; and wherein the sense voltage is output as a pair of differential sense voltages.

13. The electronic device of claim 12, further comprising an analog to digital converter coupled to the output of each of the plurality of current to voltage converters and configured to generate a digital sense voltage from the sense voltage.

14. The electronic device of claim 12, further comprising a plurality of amplifiers, each amplifier associated with one of the plurality of current to voltage converters and configured to reject a common mode current present at inputs of its associated current to voltage converter.

15. An electronic device, comprising:
a first current conveyor having first and second inputs and first and second outputs, the first input of the first current conveyor being coupled to a first self capacitance;
a second current conveyor having first and second inputs and first and second outputs, the first input of the second current conveyor being coupled to a second self capacitance;
a driver coupled to the second input of the first current conveyor and the second input of the second current conveyor, wherein the driver is configured to periodically drive the second inputs of the first and second current conveyors between high and low voltages;
a first current to voltage converter having a first input coupled to the second output of the first current conveyor, a second input coupled to the first output of the second current conveyor, and configured to output a first sense voltage; and
a second current to voltage converter having a first input coupled to the second output of the second current conveyor, a second input to be coupled to an additional current conveyor, and configured to output a second sense voltage.

16. The electronic device of claim 15, wherein the first and second current to voltage converters are differential integrators, each having differential inputs and differential outputs; and wherein the first sense voltage is output as a pair of first differential sense voltages and the second sense voltage is output as a pair of second differential sense voltages.

17. The electronic device of claim 15, further comprising a first common mode rejection circuit coupled to the first and second inputs of the first current to voltage converter, and a second common mode rejection circuit coupled to the first and second inputs of the second current to voltage converter.

18. The electronic device of claim 15, further comprising an analog to digital converter coupled to receive output from the first and second current to voltage converters and configured to generate first and second digital sense voltages from the first and second sense voltages.

19. A touch screen controller, comprising:
a current conveyor having first and second inputs and first and second outputs, the first input of the current conveyor being coupled to a self capacitance sense line; and
a driver coupled to the second input of the current conveyor, wherein the driver is configured to periodically drive the second input of the current conveyor between high and low voltages;
wherein the current conveyor is configured to force its first input to a same voltage as its second input, and to replicate a current flowing into its first input at its first and second outputs, such that:
when the driver drives the second input of the current conveyor to the high voltage, a first current flows from the first input of the current conveyor into the self capacitance sense line; and
when the driver drives the second input of the current conveyor to the low voltage, a second current flows from the self capacitance sense line into the first input of the current conveyor, and the current conveyor replicates the second current to its first and second outputs as a sense current for the self capacitance sense line.

20. The touch screen controller of claim 19, further comprising a current to voltage converter configured to convert the sense current to a sense voltage.

21. A touch screen controller, comprising:
a first current conveyor configured to charge a first self capacitance line, discharge the first self capacitance line, sense a first current resulting from discharge of the first self capacitance line, and replicate the sensed first current to first and second outputs as a first sense current for the first self capacitance line;
a second current conveyor configured to charge a second self capacitance line, discharge the second self capacitance line, sense a second current resulting from discharge of the second self capacitance line, and replicate the sensed second current to first and second outputs as a second sense current for the second self capacitance line;
a differential integrator coupled to receive the first and second sense currents and to generate a sense voltage as a function of a difference between the first and second sense currents.

22. The touch screen controller of claim 21, further comprising a common mode feedback circuit coupled between differential inputs of the differential integrator.

23. The touch screen controller of claim 21, further comprising an analog to digital converter coupled to receive output from the differential integrator and configured to generate a digital sense voltage from sense voltage.
